(19) United States
(12) Patent Application Publication
(10) Pub. No.: US 2015/0337143 A1
(43) Pub. Date: Nov. 26, 2015

(54) Antifouling Coating Composition

(71) Applicant: PPG COATINGS EUROPE B.V., Amsterdam (NL)

(72) Inventors: Christine Simone Bressy, La Valette-du-Var (FR); Marlene Aline Lejars, La Valette-du-Var (FR); Andre Paul Margaillan, La Valette-du-Var (FR); Marcel Vos, Amsterdam (NL); Michel Gillard, Amsterdam (NL)

(21) Appl. No.: 14/410,331

(22) PCT Filed: Jun. 21, 2013
(86) PCT No.: PCT/EP2013/063063

§ 371 Date: Dec. 22, 2014

(30) Foreign Application Priority Data
Jun. 22, 2012 (EP) 12173285.3

(51) Int. Cl. C09D 5/16; C09D 153/00; C08F 299/04

(52) U.S. Cl. CPC C09D 5/1668; C08F 299/04; C09D 153/00

(57) ABSTRACT

An antifouling coating composition for application to a surface is described. The coating comprises a block copolymer binder. The copolymer includes at least two polymer blocks A and B, at least 50% of the monomer units in block A being monomer residues of ethylenically unsaturated carboxylic, sulfonic or phosphonic acids. The monomer residues have silyl ester side groups containing at least 3 silicon atoms in the silyl group. A substrate coated with the coating, a block copolymer binder and a process for producing a block copolymer binder are also described.

The present invention relates to novel antifouling coating compositions, binders, processes for their production, coatings and substrates coated with such coatings. In particular, the invention relates to such coatings and compositions with improved properties in relation to the removal of fouling organisms.

The presence of fouling on submerged structures can lead to a reduction in their performance, such as damage to static structures and underwater equipment or reduced speed and increased fuel consumption in ships. Antifouling coatings have therefore been used to combat the detrimental effects of such fouling.

Conventional antifouling coatings are primarily composed of one or more biocides incorporated into a paint matrix. One such family of marine coatings, the highly successful self-polishing antifouling coatings based on organotin (TBT) polymers, has now been banned by legislation. Accordingly, marine coating chemists are currently trying to provide alternative tin-free, self-polishing polymers to match the effectiveness of TBT polymers.

Self-polishing antifouling coatings tend to be of the type which have hydrolysable groups which hydrolyse at a suitable rate in contact with fresh or sea water, generally sea water. Such coatings may incorporate biocidal materials which are released into the environment upon hydrolysis. However, in addition, the self-polishing effect of the hydrolysis also reduces the ability of marine organisms to attach to the surface of the vessel or underwater structure. Self-polishing coatings which can reduce the attachment of marine organisms, either without the use of biocides or with the use of reduced biocides, are desirable because of the reduced toxicity and therefore environmental impact of such coatings.

Fouling release coatings are a different type of coating which rely on low-surface energy to prevent fouling organisms from adhering to the surface of the coated substrate. However, such coatings can be undesirable in a ship building environment because the “non-stick” nature of the coating can contaminate surrounding coating areas and cause delamination or reduced adhesion of other types of coating such as primers, build coats and top coats.

In general, marine coatings that hinder attachment of marine organisms are of these two types i.e. self-polishing coatings and fouling release coatings. It is one of the objects of the present invention to provide an improved coating to prevent adhesion of marine organisms.

WO2010045728 discloses low surface energy coatings based on polystyrene block copolymers of the type AB wherein the polymer blocks have different levels of hydrophobicity.

The block copolymers include polystyrene-poly 2 or 4-vinyl pyridine, polystyrene-polymethylmethacrylate, polystyrene-polyethyleneoxide and polystyrene-polyethylene glycol. Variations of these with ABC or ABA blocks are also disclosed. In addition, the blocks can be modified with chemical groups that render the blocks more hydrophilic or more hydrophobic. Examples of such modifying groups are fluorinated and ethylene oxide groups.

US 20110015099A1 discloses non-bioadhesive polymers which include monomer residues of tris-[trimethylsiloxysilyl] (TRIS) groups. Tris-trimethylsilylpropylmethacrylate (M3T) copolymers and terpolymers are identified. Silyl esters are not taught and block copolymers are not exemplified.

U.S. Pat. No. 6,828,030B teaches block copolymers of polyoxyalkylene containing mercapto compounds and silyl ester copolymers. The block copolymers are claimed to exhibit a good balance of properties including less cracking tendency and good adhesion whilst maintaining controlled hydrolysis. Silyl ester side groups with siloxane groups are not exemplified. There is no indication of the block copolymers having antifouling and fouling release properties.

According to the present invention there is provided an antifouling coating composition for application to a surface, preferably a metal such as a steel surface, for example underwater structures such as ship's hulls, comprising a block copolymer binder the said copolymer including at least two polymer blocks A and B, at least 50% of the monomer units in block A being:—
(a) monomer residues of ethylenically unsaturated carboxylic, sulfonic or phosphonic acids wherein the said monomer residues have silyl ester side groups containing at least 3 silicon atoms in the silyl group.

Typically, at least 50% of the monomer units in block B are:—
(b) monomer units other than (a).

Preferably, at least 80% of the monomer units in block B are monomer units other than those of type (a), more preferably, at least 95%, most preferably, at least 99%, especially 100%.

Advantageously, the block copolymer of the invention has a lower surface energy when coated on a substrate than the corresponding statistical copolymer formed of the same monomers as those of block A and B, providing an enhanced fouling release property in the coating.

Polymer blocks A and/or B may be homopolymer blocks or copolymer blocks. Preferably, at least 80% of the monomer units of block A are monomer residues of ethylenically unsaturated carboxylic, sulfonic or phosphonic acids having silyl ester side groups containing at least 3 silicon atoms in the silyl group, more preferably, at least 90%, most preferably, about 100%.

For the avoidance of doubt, the polymer block A of the invention may be obtained from polymerisation of the silyl ester of the relevant acid monomer or the acid groups of the relevant acid monomer residues may be esterified post polymerisation. It will be appreciated that the post polymerisation esterification may not necessarily be complete so that some of the acid residues in block A may not be silylated with the said silyl group. Typically, however, at least 55% of the monomer residues in block A are silylated with the said silyl group, more preferably, at least 75%, most preferably, at least 90%. Typically, between 60-100% of the residues in block A are silyl ester residues, more typically, 80-100%, most typically, 90-100%, especially, about 100%.

In relation to block A, the ethylenically unsaturated carboxylic acid residues having the silyl ester side group, although (alk)acrylic acid such as the (C₀-C₈ alk) acrylic acid mentioned above, more preferably, (meth)acrylic acid residues are preferred, the polymer having the silyl ester side group may be derived from any other polymerisable ethylenically unsaturated monomer or polymer derived therefrom having acid functionality on the side chains thereof and capable of forming the silyl ester thereof such as itaconic, maleic, fumaric, crotonic. In addition, the invention extends to suitable sulfonic or phosphonic acid equivalents of the above acrylic and other monomers. An ethylenically unsaturated carboxylic acid is preferred. Accordingly, the polymer block A may be acrylic based or derived from other suitable monomers.

More generally, the polymer block A of the present invention may be at least partially derived from any known unsaturated monomer or polymer having acid groups in the side chains or the terminal groups, more preferably, acid groups of formula —Z(OH)ₓ where X is an integer from 1-3 and

wherein Z is selected from the following:

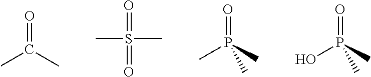

Preferably, the unsaturated carboxylic, sulfonic or phosphonic acid is (C₀₋₈ alk) acrylic acid, more preferably, acrylic acid or methacrylic acid, most preferably, methacrylic acid.

Preferably, the silyl group of the silyl ester monomer is represented by formula (I):—

—(Si(R⁴R⁵)—O)ₙ—Si—(R¹R²R³) (I)

wherein each R⁴ and R⁵ is independently selected from —O—SiR¹R²R³, or —O—(SiR⁴R⁵O)ₙ—SiR¹R²R³ or may be hydrogen or hydroxyl or may be independently selected from a C₁-C₂₀ hydrocarbyl radical,
and R¹, R² and R³ each independently represent hydrogen, hydroxyl, or may be independently selected from a C₁-C₂₀ hydrocarbyl radical,
and preferably when R⁴ or R⁵ is the radical —O—(SiR⁴R⁵O)ₙ—SiR¹R²R³, R⁴ and R⁵ within that said radical are not themselves —O—(SiR⁴R⁵O)ₙ—SiR¹R²R³,
and wherein each n independently represents a number of —Si(R⁴)(R⁵)—O— units from 1 to 1000 with the proviso that when no R⁴ and R⁵ group present in the silyl group includes a silicon atom n is at least 2.

A C₁-C₂₀ hydrocarbyl radical herein represents an alkyl, aryl, alkoxyl, acyl, aryloxyl, alkenyl, alkynyl, aralkyl, or aralkyloxyl radical which may where possible include branched, linear or cyclic parts optionally substituted by one or more substituents independently selected from the group comprising hydroxyl, silyl, —O—SiR¹R²R³, —O—(SiR⁴R⁵O)ₙ—SiR¹R²R³, halogen, nitro, amino (preferably, tertiary amino) or amino alkyl radicals and/or interrupted by one or more nitrogen, oxygen, sulphur, —C(O)—, —C(O)O— or —C(O)NH— radicals and/or terminated by —C(O)—H, —C(O)OH, or —C(O)NH₂ radicals. Of the above, a C1-C10 hydrocarbyl radical is more preferred, particularly a C1-C4 aliphatic hydrocarbyl radical, more particularly, methyl, ethyl, propyl, isopropyl, butyl, isobutyl, tertiary butyl or methoxyl, most particularly, methyl.

Preferably, R⁴ and R⁵ each independently represent an alkyl, an alkoxyl, an aryl, an hydroxyl group, a —O—SiR¹R²R³, or a —O—(SiR⁴R⁵O)ₙ—SiR¹R²R³ group, wherein R¹, R², R³, R⁴ and R⁵ are as defined above and wherein preferably, n=1-50, more preferably n=1-10, for example n=1, 2, 3, 4 or 5.

More preferably, R⁴ and R⁵ are each independently selected from the group comprising an alkyl group, a hydroxyl group, an alkoxyl group, a —O—SiR¹R²R³ group, or a —O—(SiR⁴R⁵O)ₙ—SiR¹R²R³ group.

Most preferably, R⁴ and R⁵ are each independently selected from the group comprising an alkyl group, a —O—(SiR⁴R⁵O)ₙ—SiR¹R²R³ group and a —O—SiR¹R²R³ group, as previously defined.

According to an embodiment of the present invention, R¹, R², R³, R⁴ and R⁵ are each independently selected from the group comprising methyl, ethyl, propyl, isopropyl, isobutyl, n-butyl, sec-butyl, t-butyl. Preferably, when they are alkyl groups, R⁴ and R⁵ are methyl or ethyl, more preferably methyl, most preferably, one or both R⁴ and R⁵ are methyl.

When R¹, R² and R³ are alkyl groups they are preferably independently selected from the group consisting of C₁-C₈ alkyl groups, more preferably C₁-C₄ alkyl groups, most preferably methyl, isopropyl and n-butyl. The said alkyl groups may be branched or linear and, optionally, substituted as aforesaid.

When R⁴ or R⁵ are alkoxyl, they are preferably, C₁-C₈ oxyl groups which may be branched or linear, more preferably, C₁-C₄ oxyl groups, most preferably, a methoxyl group.

Preferably, when any one of the R⁴-R⁵ groups is selected as —O—SiR¹R²R³ or —O—(SiR⁴R⁵O)ₙ—SiR¹R²R³ and such groups are substituted, the substitution is at the R¹-R⁵ groups and is preferably, by hydroxyl, silyl, halogen, amino or amino alkyl.

Preferably, at least one of R⁴ or R⁵ in general formula (I), notably at least one of R⁴ or R⁵ attached to the Si adjacent to the polymer backbone in general formula (I), is selected from —O—(SiR⁴R⁵O)ₙ—SiR¹R²R³ or —O—SiR¹R²R³, preferably at least one of R⁴ or R⁵, notably at least one of R⁴ or R⁵ attached to the Si adjacent to the polymer backbone in general formula (I), is —O—SiR¹R²R³, more preferably, both R⁴ and R⁵ attached to the same Si in general formula (I) are selected from —O—(SiR⁴R⁵O)ₙ—SiR¹R²R³ or —O—SiR¹R²R³, notably both R⁴ and R⁵ attached to the Si adjacent to the polymer backbone in general formula (I) are selected from —O—(SiR⁴R⁵O)ₙ—SiR¹R²R³ or —O—SiR¹R²R³, most preferably both R⁴ and R⁵ attached to the same Si in general formula (I) are —O—SiR¹R²R³, notably both R⁴ and R⁵ attached to the Si adjacent to the polymer backbone in general formula I are —O—SiR¹R²R³.

Suitable examples of silyl ester monomers for block A include MAD3M and MATM2 i.e. 1-(methacryloyloxy)-1,1,3,3,5,5,7,7,7-nonamethyl-tetrasiloxane and 3-(methacryloyloxy)-1,1,1,3,5,5,5-heptamethyl-trisiloxane.

Suitably, as noted above, each n independently represents a number of —Si(R⁴)(R⁵)—O— units, and wherein each n independently represents from 1 to 1000, preferably in the range 1 to 500, more preferably in the range 1 to 50, most preferably in the range 1 to 20, for example, 1, 2, 3, 4 or 5, e.g. 1.

Preferably, the side chains of formula (I) are present on 1-100% of the residual monomer units in the polymer block A, more preferably, 50-100%, most preferably, 80-100% of the monomer units.

Preferably, the group of formula (I) is present in the block copolymer in the range 1-99% w/w, more preferably, 5-75% w/w, most preferably 15-55% w/w.

In the case, where not all the monomer units of block A are type (a), suitable comonomers for block A include (i) those that contain functional groups that may be reactive with optional functional groups of the block B polymer, and (ii) those that do not include such functional groups.

Examples of functional group-containing monomers (i) that are suitable for use in preparing the block A polymer are monomers containing hydroxyl groups, amine groups, epoxy groups, and carboxylic acid groups, to name a few. Examples of monomers containing hydroxyl groups are hydroxyalkyl functional acrylates and methacrylates such as hydroxyethyl acrylate, hydroxyethyl methacrylate, hydroxypropyl acrylate, hydroxypropyl methacrylate, 4-hydroxybutyl acrylate, 4-hydroxybutyl methacrylate and the like. Mixtures of these hydroxyalkyl functional monomers may also be used. Examples of amine group-containing monomers are t-butylaminoethyl (meth)acrylate and aminoethyl (meth)acrylate. Examples of carboxylic acid group-containing monomers are (meth)acrylic acid, crotonic acid and itaconic acid. Examples of epoxy group-containing monomers include glycidyl (meth)acrylate. Examples of monomers (ii) are vinyl aromatic compounds and alkyl or aryl esters of (meth)acrylic acid or anhydride. Suitable vinyl aromatic compounds include styrene which is preferred, alpha-methylstyrene, alpha-chloromethyl styrene and vinyl toluene. Suitable alkyl esters of acrylic and methacrylic acid or anhydride include those wherein the alkyl portion of the ester contains from about 1 to about 30, preferably 4 to 30, carbon atoms, those in which the alkyl group is linear or branched, aliphatic including cycloaliphatic. Suitable specific monomers include alkyl acrylates such as methyl acrylate, n-butyl acrylate and t-butyl acrylate, 2-ethylhexyl acrylate, isobornyl acrylate, cyclohexyl acrylate, t-butyl cyclohexyl acrylate, trimethyl cyclohexyl acrylate, lauryl acrylate, and the like; alkyl methacrylates, including methyl methacrylate, n-butyl methacrylate, t-butyl methacrylate, 2-ethylhexyl methacrylate (which is preferred), isobornyl methacrylate, cyclohexyl methacrylate, t-butyl cyclohexyl methacrylate, trimethyl cyclohexyl methacrylate, and lauryl methacrylate. Suitable aryl esters include acrylate and methacrylate esters of secondary and tertiary butylphenol substituted in the 2,3 or 4 position and nonylphenol.

Preferably, both block A and block B and any additional polymer blocks are independently homopolymer blocks.

Suitable monomers for block B include but are not limited to those polymerisable or copolymerisable to form polyesters, polyurethanes, polyethers, polyacrylics, polyvinyls, polyepoxides, polyamides, polyureas and copolymers thereof. Suitable monomers or comonomers for block B include (i) those that contain functional groups that may or may not be reactive with optional functional groups of the block A polymer, and (ii) those that do not include such functional groups.

The polymer block B may comprise at least one reactive functional group selected from a hydroxyl group, a carboxyl group, an isocyanate group, a blocked isocyanate group, a primary amine group, a secondary amine group, an amide group, a carbamate group, a urea group, a urethane group, a vinyl group, an unsaturated ester group, a maleimide group, a fumarate group, an anhydride group, a hydroxy alkylamide group, and an epoxy group. The polymer block B can comprise a mixture of any of the foregoing reactive functional groups.

Polymers suitable for use as the at least one reactive functional group-containing polymer block B can include any of a variety of functional polymers known in the art. For example, suitable hydroxyl group-containing polymers can include acrylic polyols, polyester polyols, polyurethane polyols, polyether polyols, and mixtures thereof. In a particular embodiment of the present invention, the film-forming block polymer B is an acrylic polyol having a hydroxyl equivalent weight ranging from 1000 to 100 grams per solid equivalent, preferably 500 to 150 grams per solid equivalent.

Suitable hydroxyl group and/or carboxyl group-containing acrylic polymers for block B can be prepared from polymerizable ethylenically unsaturated monomers and are typically copolymers of (meth)acrylic acid and/or hydroxylalkyl esters of (meth)acrylic acid with one or more other polymerizable ethylenically unsaturated monomers such as alkyl esters of (meth)acrylic acid including methyl (meth)acrylate, ethyl (meth)acrylate, butyl (meth)acrylate and 2-ethyl hexylacrylate, and vinyl aromatic compounds such as styrene, alpha-methyl styrene, and vinyl toluene.

As used herein “(meth)acrylate” and like terms is intended to include both acrylates and methacrylates.

In one embodiment of the present invention the acrylic polymer of block B can be prepared from ethylenically unsaturated, beta-hydroxy ester functional monomers. Such monomers can be derived from the reaction of an ethylenically unsaturated acid functional monomer, such as monocarboxylic acids, for example, acrylic acid, and an epoxy compound which does not participate in the free radical initiated polymerization with the unsaturated acid monomer. Examples of such epoxy compounds include glycidyl ethers and esters. Suitable glycidyl ethers include glycidyl ethers of alcohols and phenols such as butyl glycidyl ether, octyl glycidyl ether, phenyl glycidyl ether and the like. Suitable glycidyl esters include those which are commercially available from Shell Chemical Company under the tradename CARDURA E; and from Exxon Chemical Company under the tradename GLYDEXX-10. Alternatively, the beta-hydroxy ester functional monomers can be prepared from an ethylenically unsaturated, epoxy functional monomer, for example glycidyl (meth)acrylate and allyl glycidyl ether, and a saturated carboxylic acid, such as a saturated monocarboxylic acid, for example isostearic acid.

Epoxy functional groups can be incorporated into the polymer of block B prepared from polymerizable ethylenically unsaturated monomers by copolymerizing oxirane group-containing monomers, for example glycidyl (meth)acrylate and allyl glycidyl ether, with other polymerizable ethylenically unsaturated monomers, such as those discussed above. Preparation of such epoxy functional acrylic polymers is described in detail in U.S. Pat. No. 4,001,156 at columns 3 to 6, incorporated herein by reference.

Carbamate functional groups can be incorporated into the polymer of block B prepared from polymerizable ethylenically unsaturated monomers by copolymerizing, for example, the above-described ethylenically unsaturated monomers with a carbamate functional vinyl monomer such as a carbamate functional alkyl ester of methacrylic acid. Useful carbamate functional alkyl esters can be prepared by reacting, for example, a hydroxyaikyl carbamate, such as the reaction product of ammonia and ethylene carbonate or propylene carbonate, with methacrylic anhydride. Other useful carbamate functional vinyl monomers for block B include, for instance, the reaction product of hydroxyethyl methacrylate, isophorone diisocyanate, and hydroxypropyl carbamate; or the reaction product of hydroxypropyl methacrylate, isophorone diisocyanate, and methanol. Still other carbamate functional vinyl monomers may be used for block B, such as the reaction product of isocyanic acid (HNCO) with a hydroxyl functional acrylic or methacrylic monomer such as hydroxyethyl acrylate, and those described in U.S. Pat. No. 3,479,328, incorporated herein by reference. Carbamate functional groups can also be incorporated into the acrylic polymer of block B by reacting a hydroxyl functional acrylic polymer with a low molecular weight alkyl carbamate such as methyl carbamate. Pendant carbamate groups can also be incorporated into the acrylic polymer of block B by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether. Also, hydroxyl functional acrylic polymers of block B can be reacted with isocyanic acid to provide pendent carbamate groups. Likewise, hydroxyl functional acrylic polymers can be reacted with urea to provide pendent carbamate groups.

The polymers blocks herein prepared from polymerizable ethylenically unsaturated monomers can be prepared by solution polymerization techniques, which are well-known to those skilled in the art, in the presence of suitable catalysts such as organic peroxides or azo compounds, for example, benzoyl peroxide or N,N-azobis(isobutylronitrile). The polymerization can be carried out in an organic solution in which the monomers are soluble by techniques conventional in the art. Alternatively, these polymers can be prepared by aqueous emulsion or dispersion polymerization techniques which are well-known in the art. The ratio of reactants and reaction conditions are selected to result in an acrylic polymer with the desired pendent functionality.

Polyester polymers are also useful in the coating compositions of the invention as the polymer block B. Useful polyester polymers typically include the condensation products of polyhydric alcohols and polycarboxylic acids. Suitable polyhydric alcohols can include ethylene glycol, neopentyl glycol, trimethylol propane, and pentaerythritol. Suitable polycarboxylic acids can include adipic acid, 1,4-cyclohexyl dicarboxylic acid, and hexahydrophthalic acid. Besides the polycarboxylic acids mentioned above, functional equivalents of the acids such as anhydrides where they exist or lower alkyl esters of the acids such as the methyl esters can be used. Also, small amounts of monocarboxylic acids such as stearic acid can be used. The ratio of reactants and reaction conditions are selected to result in a polyester polymer with the desired pendent functionality, i.e., carboxyl or hydroxyl functionality.

For example, hydroxyl group-containing polyesters can be prepared by reacting an anhydride of a dicarboxylic acid such as hexahydrophthalic anhydride with a diol such as neopentyl glycol in a 1:2 molar ratio. Where it is desired to enhance air-drying, suitable drying oil fatty acids may be used and include those derived from linseed oil, soya bean oil, tall oil, dehydrated castor oil, ortung oil.

Carbamate functional polyesters of block B can be prepared by first forming a hydroxyalkyl carbamate that can be reacted with the polyacids and polyols used in forming the polyester. Alternatively, terminal carbamate functional groups can be incorporated into the polyester by reacting isocyanic acid with a hydroxy functional polyester. Also, carbamate functionality can be incorporated into the polyester by reacting a hydroxyl polyester with a urea. Additionally, carbamate groups can be incorporated into the polyester by a transcarbamoylation reaction. Preparations of suitable carbamate functional group-containing polyesters are those described in U.S. Pat. No. 5,593,733 at column 2, line 40 to column 4, line 9, incorporated herein by reference.

Polyurethane polymers containing terminal isocyanate or hydroxyl groups also can be used as the polymer block B in the coating compositions of the invention. The polyurethane polyols or NCO-terminated polyurethanes which can be used are those prepared by reacting polyols including polymeric polyols with polyisocyanates. Polyureas containing terminal isocyanate or primary and/or secondary amine groups which also can be used are those prepared by reacting polyamines including polymeric polyamines with polyisocyanates. The hydroxy 1/isocyanate or amine/isocyanate equivalent ratio is adjusted and reaction conditions are selected to obtain the desired terminal groups. Examples of suitable polyisocyanates include those described in U.S. Pat. No. 4,046,729 at column 5, line 26 to column 6, line 28, incorporated herein by reference. Examples of suitable polyols include those described in U.S. Pat. No. 4,046,729 at column 7, line 52 to column 10, line 35, incorporated herein by reference. Examples of suitable polyamines include those described in U.S. Pat. No. 4,046,729 at column 6, line 61 to column 7, line 32 and in U.S. Pat. No. 3,799,854 at column 3, lines 13 to 50, both incorporated herein by reference.

Carbamate functional groups can be introduced into the polyurethane polymers of block B by reacting a polyisocyanate with a polyester having hydroxyl functionality and containing pendent carbamate groups. Alternatively, the polyurethane can be prepared by reacting a polyisocyanate with a polyester polyol and a hydroxyaikyl carbamate or isocyanic acid as separate reactants. Examples of suitable polyisocyanates are aromatic isocyanates, such as 4,4′-diphenylmethane diisocyanate, 1,3-phenylene diisocyanate and toluene diisocyanate, and aliphatic polyisocyanates, such as 1,4-tetramethylene diisocyanate and 1,6-hexamethylene diisocyanate. Cycloaliphatic diisocyanates, such as 1,4-cyclohexyl diisocyanate and isophorone diisocyanate also can be employed.

Examples of suitable polyether polyols include polyalkylene ether polyols such as those having the following structural formulas (VII) or (VIM):

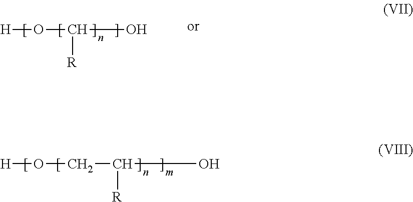

wherein the substituent R is hydrogen or a lower alkyl group containing from 1 to 5 carbon atoms including mixed substituents, and n has a value typically ranging from 2 to 6 and m has a value ranging from 8 to 100 or higher.

Exemplary polyalkylene ether polyols include poly(oxytetramethylene) glycols, poly(oxytetraethylene) glycols, poly(oxy-1,2-propylene) glycols, and poly(oxy-1,2-butylene) glycols. Also useful are polyether polyols formed from oxyalkylation of various polyols, for example, glycols such as ethylene glycol, 1,6-hexanediol, Bisphenol A, and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Specific examples of polyethers include those sold under the names TERATHANE and TERACOL, available from E. I. Du Pont de Nemours and Company, Inc.

Preferably, polymer blocks with oxyalkylene backbone groups are excluded from block B of the present invention. In addition, preferably, polymer blocks having residues of mercaptans are also excluded from block B.

Preferably, the monomer residues of block B are present in the block copolymer in the range of 5-99% w/w of the total monomer residues in the block copolymer, more preferably, 30-95% w/w, most preferably 40-70% w/w.

Preferably, the residues of block A with silyl groups are present in the block copolymer in the range 1-95% w/w of the total monomer residues in the block copolymer, more preferably, 5-70% w/w, most preferably, 30-60% w/w.

Advantageously, the present invention provides self-polishing antifouling coatings with the option of reduced biocide levels or alternatively, fouling release coatings with self-polishing properties. A problem with fouling release coatings (FRC) is that their low surface energy which prevents the adhesion of marine organisms is less effective if the underwater structure is immobile such as a ship in harbor or fixed underwater structures. Accordingly, the compositions of the present invention allow for improved FRC compositions which are effective against fouling of immobile structures.

Preferred low surface energy levels for the coating are 10-30 mJ/M² by the Owens Wendt method, more preferably, 10-25 mJ/M², most preferably, 10-20 mJ/M².

According to a second aspect of the present invention there is provided a process for producing a block copolymer binder according to the first aspect of the present invention comprising the steps of polymerizing the unsaturated carboxylic, sulfonic or phosphonic acid monomers optionally with comonomers to produce block A, polymerizing the monomers of block B optionally with comonomers to produce block B, at least 50% of the monomer units in block A being:—
(a) monomer residues of ethylenically unsaturated carboxylic, sulfonic or phosphonic acids wherein the said monomer residues have silyl ester side groups containing at least 3 silicon atoms in the silyl group.

Other preferred features are as indicated for the other aspects herein.

The block polymerization may be carried out by any suitable means known to those skilled in the art of block polymerization. Examples of suitable block polymerization processes include anionic polymerization, cationic polymerization, living polymerization or controlled radical polymerization (CRP), living cationic polymerisations, ring opening metathesis, ROMP, group transfer polymerization, direct coupling of preformed living polymerization blocks, coupling of end functionalized prepolymers, polymerization by use of bifunctional initiators, and suitable combinations of the aforesaid techniques.

In addition, the block copolymers of the invention may be modified either during or post-polymerisation by chemical modification such as esterification, especially by silyl groups as mentioned herein, hydrogenation, hydrolysis, quaternization sulfonation, hydroboration/Oxidation, epoxidation, chloro/bromomethylation and hydrosilylation. These techniques may be used in combination with any of the aforesaid polymerization techniques.

Optionally, the silyl groups of the invention are added to at least some of the monomer residues of block A by esterification of the acid side group after polymerization of polymer block A. In this case, the monomer of block A is in the form of the acid prior to polymerization. Generally, however, the silyl groups are present in the monomers of block A as the silyl ester part thereof prior to polymerization.

Suitable controlled radical polymerization techniques when used in the present invention include RAFT, NMP and ATRP polymerization.

Suitable RAFT agents for RAFT polymerization may be selected from dithiocarbamates, trithiocarbonates and dithiobenzoates. Examples include 2-cyano-2-propyl-dithiobenzoate, 4-cyano-4-(phenylcarbonothioylthio)pentanoic acid, 2-cyano-2-propyl dodecyl trithiocarbonate and 4-Cyano-4-[(dodecylsulfanylthiocarbonyl)sulfanyl]pentanoic acid.

As mentioned above polymers of block B can be connected to block A in any of a variety of ways. For example, any of these blocks could include functional groups or unsaturation that could be utilized to react with any of a variety of other monomer residues in the other block. For example, block A or block B could contain residues of monomers such as acrylic monomers having pendant epoxy, hydroxyl, and unsaturated groups. One such preferred example connection could be obtained by ring opening a pendant epoxy group on one block by reaction with an unsaturated acid on the other block.

Preferably, the antifouling coating composition further contains an antifouling effective amount of at least one biocide.

Suitably, said antifouling coating composition is an antifouling paint composition.

Preferred features of all aspects of the invention will be apparent from the dependent claims, and the description.

Suitably, within said composition, a high binder content is preferred to maximise the beneficial properties of the binder in the coating. The exact amount of effective binder will therefore depend on the application. Typically, however, said binder represents between 1-99% by weight, preferably 10-80% by weight, more preferably 15-75% by weight, most preferably 20-60% by weight, for example about 35-45% by weight, e.g. about 40% by weight, of the composition.

The Mw of each block is not particularly restricted. The Mw should be chosen so that good film forming properties are obtained. However, in general Mw may be from 5000 up to 500,000 Daltons, more preferably, 1000 to 200,000 Daltons, most preferably, 10000 to 150,000 Daltons as determined by GPC (size exclusion chromatography). Accordingly, the Mw of the block copolymer may be 10000 to 1,000,000 Daltons, more preferably, 20000 to 500,000 Daltons, most preferably, 20000 to 300,000 Daltons as determined by GPC (size exclusion chromatography).

### DEFINITIONS

As used herein, the term “independently”, “independently selected”, “independently represent” or the like indicates that the each radical so described, can be identical or different. The term “about” means within +/−5%, more typically, +/−1%. When, in general formula (I) for instance, n>1, then each R⁴, or each R⁵, within the particular (SiR⁴R⁵O)ₙ, group can be the same as or different to the other R⁴ and R⁵ groups, respectively, within the particular (SiR⁴R⁵O)ₙ group. Moreover, if there are more than one (—SiR¹R²R³) groups present, each R¹, each R² and each R³ can be the same as or different to the other R¹, R² and R³ groups present in the overall formula.

The term “alk” or “alkyl”, as used herein unless otherwise defined, relates to saturated hydrocarbon radicals being straight, branched, cyclic or polycyclic moieties or combinations thereof and unless otherwise indicated contains 1 to 20 carbon atoms, preferably 1 to 10 carbon atoms, more preferably 1 to 8 carbon atoms, still more preferably 1 to 6 carbon atoms, yet more preferably 1 to 4 carbon atoms. These radicals may be optionally substituted with a halo, cyano, nitro, OR¹⁹, OC(O)R²⁰, C(O)R²¹, C(O)OR²², NR²³R²⁴, C(O)NR²⁹R²⁶, SR²⁷, C(O)S R²⁷, C(S)NR²⁹R²⁶, aryl or Het, wherein R¹⁹ to R²⁷ each independently represent hydrogen, aryl or alkyl, and/or be interrupted by one or more oxygen or sulphur atoms, or by silano or dialkylsilcon groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like.

The term “alkenyl”, as used herein, relates to hydrocarbon radicals having one or several, preferably up to 4, more preferably, 1 or 2, most preferably 1 double bond(s), being straight, branched, cyclic or polycyclic moieties or combinations thereof and containing from 2 to 18 carbon atoms, preferably 2 to 10 carbon atoms, more preferably from 2 to 8 carbon atoms, still more preferably 2 to 6 carbon atoms, yet more preferably 2 to 4 carbon atoms. These radicals may be optionally substituted with a hydroxyl, halo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by one or more oxygen or sulphur atoms, or by silano or dialkylsilcon groups. Examples of such radicals may be independently selected from alkenyl groups which include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like.

The term “alkynyl”, as used herein, relates to hydrocarbon radicals having one or several, preferably up to 4, more preferably, 1 or 2, most preferably, 1 triple bond(s), being straight, branched, cyclic or polycyclic moieties or combinations thereof and having from 2 to 18 carbon atoms, preferably 2 to 10 carbon atoms, more preferably from 2 to 8 carbon atoms, still more preferably from 2 to 6 carbon atoms, yet more preferably 2 to 4 carbon atoms. These radicals may be optionally substituted with a hydroxy, halo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or lower alkyl, and/or be interrupted by one or more oxygen or sulphur atoms, or by silano or dialkylsilcon groups. Examples of such radicals may be independently selected from alkynyl radicals which include ethynyl, propynyl, propargyl, butynyl, pentynyl, hexynyl and the like.

The term “aryl” as used herein, relates to an organic radical derived from an aromatic hydrocarbon by removal of one hydrogen, and includes any monocyclic, bicyclic or polycyclic carbon ring of up to 7 members in each ring, wherein at least one ring is aromatic. These radicals may be optionally substituted with a hydroxy, halo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or lower alkyl, and/or be interrupted by one or more oxygen or sulphur atoms, or by silano or dialkylsilcon groups. Examples of such radicals may be independently selected from phenyl, p-tolyl, 4-methoxyphenyl 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like.

The term “aralkyl” as used herein, relates to a group of the formula alkyl-aryl, in which alkyl and aryl have the same meaning as defined above and may be attached to an adjacent radical via the alkyl or aryl part thereof. Examples of such radicals may be independently selected from benzyl, phenethyl, dibenzylmethyl, methylphenylmethyl, 3-(2-naphthyl)-butyl, and the like.

The term “Het”, when used herein, includes four-to-twelve-membered, preferably four-to-ten-membered ring systems, which rings contain one or more heteroatoms selected from nitrogen, oxygen, sulphur and mixtures thereof, and which rings may contain one or more double bonds or be non-aromatic, partly aromatic or wholly aromatic in character. The ring systems may be monocyclic, bicyclic or fused. Each “Het” group identified herein is optionally substituted by one or more substituents selected from halo, cyano, nitro, oxo, lower alkyl, OR¹⁹, OC(O)R²⁰, C(O)R²¹, C(O)OR²², NR²³R²⁴, C(O)NR²⁵R²⁶, SR²⁷, C(O)SR²⁷ or C(S)NR²⁵R²⁶ wherein R¹⁹ to R²⁷ each independently represent hydrogen, aryl or lower alkyl. The term “Het” thus includes groups such as optionally substituted azetidinyl, pyrrolidinyl, imidazolyl, indolyl, furanyl, oxazolyl, isoxazolyl, oxadiazolyl, thiazolyl, thiadiazolyl, triazolyl, oxatriazolyl, thiatriazolyl, pyridazinyl, morpholinyl, pyrimidinyl, pyrazinyl, quinolinyl, isoquinolinyl, piperidinyl, pyrazolyl and piperazinyl. Substitution at Het may be at a carbon atom of the Het ring or, where appropriate, at one or more of the heteroatoms.

“Het” groups may also be in the form of an N oxide.

For the avoidance of doubt, the reference to alkyl, alkenyl, alkynyl, aryl or aralkyl in composite groups should be interpreted accordingly, for example the reference to alkyl in aminoalkyl or alk in alkoxyl should be interpreted as alk or alkyl above etc.

The use of parenthesis in the terms “(alk)acrylate” or “(meth)acrylate” as used herein optionally refers to alkacrylate, methacrylate or the non-alk or non-meth acrylate respectively.

The term “silyl” as used herein includes —SiR¹R²R³ and —(SiR⁴R⁵O)ₙ—SiR¹R²R³ groups wherein R¹—R⁵ are as defined herein and the term “silyl ester side group” means, in the case of an acid, the silyl group bonded to an oxy radical of the acid group to form an O—Si ester bond.

The term “lower alkyl” or the like herein has the same definition as “alkyl” above except that it is restricted to 1 to 6 carbon atoms.

The term “block copolymer” as used herein includes unless otherwise indicated to the contrary cyclic or linear AB diblock copolymers, ABC tri or further ABCD etc block copolymers, ABA triblock copolymers; (AB)ₙ star and multiblock copolymers; AₙBₙ star block copolymers; and graft copolymers.

### Additives

Pigments, antifouling agents, solvents and other additives can be added to the polymers of the invention to produce the appropriate coating and are well known in the art.

Suitable solvents for the antifouling coating composition of the present invention include acetates, ketones and non functional group containing aromatic compounds such as ethyl acetate, butyl acetate, methylethyl ketone, methyl isobutyl ketone, ethylene glycol monoethylether acetate, methoxypropyl acetate, toluene, xylene, white spirit, ethoxypropyl acetate, ethoxyethyl propionate, methoxybutyl acetate, butyl glycol acetate, solvent naphtha, n-butanol and mixtures of these solvents. The solvents are used in a quantity of up to 70% by weight, preferably up to 40% by weight, based on the weight of the antifouling composition.

Further additives to be used if required are, for example, plasticizers such as, for example, tricresyl phosphate, phthalic diesters or chloroparaffins; pigments such as colour pigments, bright pigments, and extender pigments and fillers, such as titanium oxide, barium sulphate, chalk, carbon black; levelling agents; thickeners; stabilizers, such as substituted phenols or organo functional silanes. Adhesion promoters and light stabilizers may also be utilised.

Antifoulants (biocides) although not essential to the present invention may be used as a component in the coating composition of the present invention and may be any of one or more conventionally known antifoulants. The known antifoulants are roughly divided into inorganic compounds, metal-containing organic compounds, and metal-free organic compounds.

Examples of the inorganic compounds include copper compounds (e.g. copper sulphate, copper powder, cuprous thiocyanate, copper carbonate, copper chloride, and the traditionally preferred cuprous oxide), zinc sulphate, zinc oxide, nickel sulphate, and copper nickel alloys.

Examples of the metal-containing organic compounds include organo-copper compounds, organo-nickel compounds, and organo-zinc compounds. Also usable are manganese ethylene bis dithiocarbamate (maneb) or propineb. Examples of the organo-copper compounds include copper nonylphenol-sulphonate, copper bis(ethylenediamine) bis(dodecylbenzene sulphonate), copper acetate, copper naphthenate, copper pyrithione and copper bis(pentachlorophenolate). Examples of the organo-nickel compounds include nickel acetate and nickel dimethyl dithiocarbamate. Examples of the organo-zinc compounds include zinc acetate, zinc carbamate, bis(dimethylcarbamoyl) zinc ethylene-bis(dithiocarbamate), zinc dimethyl dithiocarbamate, zinc pyrithione, and zinc ethylene-bis(dithiocarbamate). As an example of mixed metal-containing organic compound, one can cite (polymeric) manganese ethylene bis dithiocarbamate complexed with zinc salt (mancozeb).

Examples of the metal-free organic compounds include N-trihalomethylthiophthalimides, trihalomethylthiosulphamides, dithiocarbamic acids, N-arylmaleimides, 3-(substituted amino)-1,3 thiazolidine-2,4-diones, dithiocyano compounds, triazine compounds, oxathiazines and others.

Examples of the N-trihalomethylthiophthalimides include N-trichloromethylthiophthalimide and N-fluorodichloromethylthiophthalimide.

Examples of the dithiocarbamic acids include bis(dimethylthiocarbamoyl) disulphide, ammonium N-methyldithiocarbamate and ammonium ethylene-bis(dithiocarbamate).

Examples of trihalomethylthiosulphamides include N-(dichlorofluoromethylthio)-N′,N′-dimethyl-N-phenylsulphamide and N-(dichlorofluoromethylthio)-N′,N′-dimethyl-N-(4-methylphenyl)sulphamide.

Examples of the N-arylmaleimides include N-(2,4,6-trichlorophenyl)maleimide, N-4 tolylmaleimide, N-3 chlorophenylmaleimide, N-(4-n-butylphenyl)maleimide, N-(anilinophenyl)maleimide, and N-(2,3-xylyl)maleimide.

Examples of the 3-(substituted amino)-1,3-thiazolidine-2,4-diones include 2-(thiocyanomethylthio)-benzothiazole, 3-benzylideneamino-1,3-thiazolidine-2,4-dione, 3-(4-methylbenzylideneamino)-1,3-thiazolidine-2,4-dione, 3-(2-hydroxybenzylideneamino)-1,3-thiazolidine-2,4-dione, 3-(4-dimethylaminobenzylideamino)-1,3-thiazolidine-2,4-dione, and 3-(2,4-dichlorobenzylideneamino)-1,3-thiazolidine-2,4-dione.

Examples of the dithiocyano compounds include dithiocyanomethane, dithiocyanoethane, and 2,5-dithiocyanothiophene.

Examples of the triazine compounds include 2-methylthio-4-butylamino-6-cyclopropylamino-s-triazine.

Examples of oxathiazines include 1,4,2-oxathiazines and their mono- and di-oxides such as disclosed in PCT patent WO 98/05719: mono- and di-oxides of 1,4,2-oxathiazines with a substituent in the 3 position representing (a) phenyl; phenyl substituted with 1 to 3 substituents independently selected from hydroxyl, halo, C1-12 alkyl, C5-6 cycloalkyl, trihalomethyl, phenyl, C1-C5 alkoxy, C1-5 alkylthio, tetrahydropyranyloxy, phenoxy, C1-4 alkyl carbonyl, phenyl carbonyl, C1-4 alkylsulfinyl, carboxy or its alkali metal salt, C1-4 alkoxycarbonyl, C1-4 alkylaminocarbonyl, phenylaminocarbonyl, tolylaminocarbonyl, morpholinocarbonyl, amino, nitro, cyano, dioxolanyl or C1-4 alkyloxyiminomethyl; naphthyl; pyridinyl; thienyl; furanyl; or thienyl or furanyl substituted with one to three substituents independently selected from C1-C4 alkyl, C1-4 alkoxy, C1-4 alkylthio, halo, cyano, formyl, acetyl, benzoyl, nitro, C1-C4 alkoxycarbonyl, phenyl, phenylaminocarbonyl and C1-4 alkyloxyiminomethyl; or (b) a substituent of generic formula

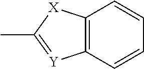

wherein X is oxygen or sulphur; Y is nitrogen, CH or C(C1-4 alkoxy); and the C6 ring may have one C1-4 alkyl substituent; a second substituent selected from C1-4 alkyl or benzyl being optionally present in position 5 or 6.

Other examples of the metal-free organic compounds include 2,4,5,6-tetrachloroisophthalonitrile, N,N-dimethyl-dichlorophenylurea, 4,5-dichloro-2-n-octyl-4-isothiazoline-3-one, N,N-dimethyl-N′-phenyl-(N-fluorodichloromethylthio)-sulfamide, tetramethylthiuramdisulphide, 3-iodo-2-propinylbutyl carbamate, 2-(methoxycarbonylamino)benzimidazole, 2,3,5,6-tetrachloro-4-(methylsulphonyl)pyridine, diiodomethyl-p-tolyl sulphone, phenyl(bispyridine)bismuth dichloride, 2-(4-thiazolyl)benzimidazole, dihydroabietyl amine, N-methylol formamide and pyridine triphenylborane.

According to a preferred embodiment, the use as antifoulant of the oxathiazines disclosed in WO-A-9505739 has the added advantage (disclosed in EP-A-823462) of increasing the self-polishing properties of the paint.

Among the fouling organisms, barnacles have proved to be the most troublesome, because they are resistant to most biocides. Accordingly, the paint formulation may also include at least an effective amount of at least one specific barnaclecide, such as cuprous oxide or thiocyanate. A preferred barnaclecide is disclosed in EP-A-831134. EP-A-831134 discloses the use of from 0.5 to 9.9 wt %, based on the total weight of the dry mass of the composition, of at least one 2-trihalogenomethyl-3-halogeno-4-cyano pyrrole derivative substituted in position 5 and optionally in position 1, the halogens in positions 2 and 3 being independently selected from the group consisting of fluorine, chlorine and bromine, the substituent in position 5 being selected from the group consisting of C1-8 alkyl, C1-8 monohalogenoalkyl, C5-6 cycloalkyl, C5-6 monohalogenocycloalkyl, benzyl, phenyl, mono- and di-halogenobenzyl, mono- and di-halogenophenyl, mono- and di-C1-4-alkyl benzyl, mono- and di-C1-4-alkyl phenyl, monohalogeno mono-C1-4-alkyl benzyl and monohalogeno mono-C1-4-alkyl phenyl, any halogen on the substituent in position 5 being selected from the group consisting of chlorine and bromine, the optional substituent in position 1 being selected from C1-4 alkyl and C1-4 alkoxy C1-4 alkyl.

An alternative barnaclecide is Medetomidine (commercial name Selektope); chemical name 4-[1-(2,3-dimethylphenyl)ethyl]1H-imidazole (cas no. 86347-14-0). Medetomidine may be present in the range 0.05 wt %-0.5 wt %

One or more antifoulants selected from the above antifoulants may be employed in the present invention. The antifoulants are used in such an amount that the proportion thereof in the solid contents of the coating composition is usually from 0.05 to 90% by weight, preferably 0.05 to 80% by weight, and more preferably from 0.5 to 60% by weight. Too little antifoulant does not produce an antifouling effect, while too much antifoulant results in the formation of a coating film which is apt to develop defects such as cracking and peeling and thus becomes less effective in its antifouling property.

The above plasticizer includes, for example, phthalate-based plasticizers such as dioctyl phthalate, dimethyl phthalate, dicyclohexyl phthalate; aliphatic dibasic ester-based plasticizers such as diisobutyl adipate, dibutyl sebacate; glycol ester-based plasticizers such as diethylene glycol dibenzoate, pentaerythritol alkyl ester; phosphate-based plasticizers such as tricresyl phosphate, trichloroethyl phosphate; epoxy-based plasticizers such as epoxylated soybean oil, octyl epoxy stearate; organic tin-based plasticizers such as dioctyltin laurate, dibutyltin laurate; and trioctyl trimellitate, triacetylene.

The above pigment includes, for example, extender pigments such as precipitated barium sulfate, talc, clay, chalk, silica white, alumina white, bentonite; and color pigments such as titanium oxide, zirconium oxide, basic lead sulfate, tin oxide, carbon black, graphite, red iron oxide, chromium yellow, phthalocyanine green, phthalocyanine blue, quinacridone.

Besides those described above, other additives are not particularly limited, and include, for example, rosin, organic monobasic acids such as monobutyl phthalate and monoctyl succinate, camphor, castor oil.

The antifouling coating composition of the present invention can be prepared for example by adding conventional additives such as other binder resins, an antifouling agent, a plasticizer, a coating-abrasion regulator, a pigment, a solvent to the above resin composition comprising the block copolymer according to the present invention and then mixing them by a mixer such as a ball mill, a pebble mill, a roll mill, a sand grind mill.

A dry coating film can be formed by applying the antifouling coating composition described above in a usual manner onto the surface of a substrate to be coated and then removing the solvent through evaporation at ordinary temperature or under heating. The coating composition of the present invention may be applied to the substrate by any conventional coating technique such as brushing, spraying, dipping or flowing, but spray applications are preferred. Any of the known spraying techniques may be employed such as compressed air spraying, electrostatic spraying and either manual or automatic methods. The coating composition of the invention may be applied directly to the substrate, typically, however, it is applied to a primer or build coat already on the substrate such that it forms an outer layer of the coated substrate and is thereby exposed directly to the marine and/or other fouling environment. One or more coatings of the composition may be applied.

Accordingly, the invention extends to a substrate, preferably a metal, more preferably, a steel substrate such as an underwater structure for example a ship's hull coated with an antifouling coating composition according to the present invention.

Features and embodiments of each aspect of the present invention are hereby stated to be features and embodiments of each and every other aspect of the present invention, unless otherwise stated or unless mutually exclusive.

The invention will now be described by way of illustration only and with reference to the accompanying illustrative examples and figures in which:—

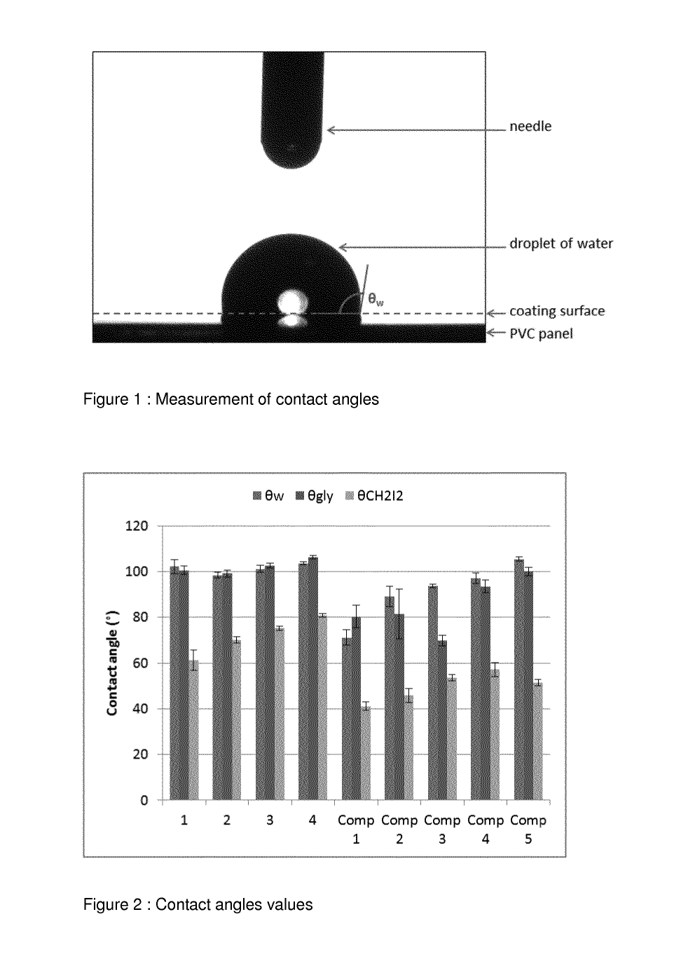

FIG. 1 illustrates the measurement of contact angle;

FIG. 2 shows the static contact angles for various binder coatings; and

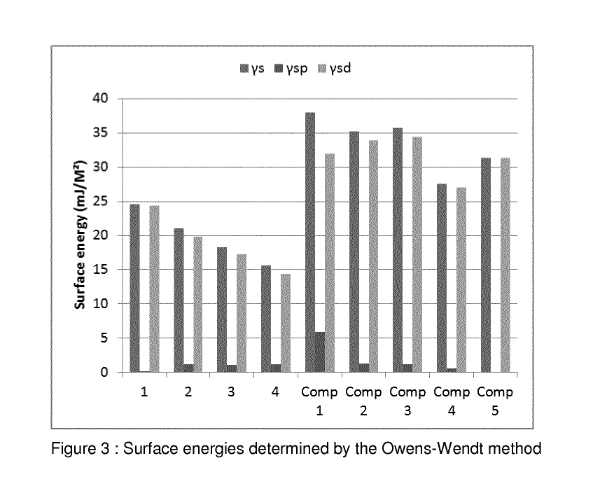

FIG. 3 shows the surface energy for various binder coatings.

### EXAMPLES

### Synthesis of Block Copolymer

### Materials:

Methyl methacrylate (MMA) purchased from Acros, and bis(trimethylsiloxy)methylsilyl methacrylate (MATM2) supplied by Momentive Performance Materials were distilled under reduced pressure, and stored under argon before use. 2-Cyanoprop-2-yl dithiobenzoate (CPDB, CAS: 201611-85-0, 97%) was purchased from Strem Chemicals, and used without further purification. 2,2′-Azobisisobutyronitrile (AIBN) was purchased from Aldrich, and purified by recrystallization from methanol. Xylene was purchased from Acros, and distilled under reduced pressure with CaH₂ before use.

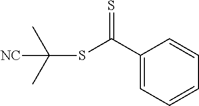

### Structure of 2-cyanoprop-2-yl-dithiobenzoate (CPDB)

### Synthesis Procedure:

Diblock copolymers were synthesized by first polymerizing MATM2 with CPDB as Chain Transfer Agent (CTA) and then adding MMA to the reaction mixture in order to polymerize MMA on the chains of pMATM2-CTA first block—scheme 1. Table 1 summarizes the characteristics of the synthesized diblock copolymers.

General Example of pMATM2-b-pMMA production, with approximate Mₙ=20,000 g/mol, containing 20 mol % of MATM2 (Example 2):

Into a 250 mL round-bottomed flask equipped with a magnetic stir bar, MATM2 (11.475 g, 37.5 mmol), CPDB (296.3 mg, 1.34 mmol) and AIBN (44.0 mg, 0.27 mmol) were dissolved in distilled xylene, and the volume of the solution was adjusted to 25 mL. Then, the reaction mixture was degassed through bubbling with argon, sealed, and then placed in an oil bath previously heated at 70° C., until a total monomer conversion (>96%). When the polymerization was achieved, a 50 mL-solution of MMA (15.0 g, 0.15 mol) and AIBN (44 mg, 0.3 mmol) in distilled xylene, previously degassed, was added to the reaction mixture. The polymerization was conducted until no evolution of the monomer conversion. The polymer was precipitated into methanol, filtered and dried under vacuum for 48 h at room temperature for further characterizing its absolute number average molecular weight and polydispersity index (PDI).

Example 1, 3 and 4 were produced in the same manner as example 2 except the ratios of MATM2: MMA were varied accordingly.

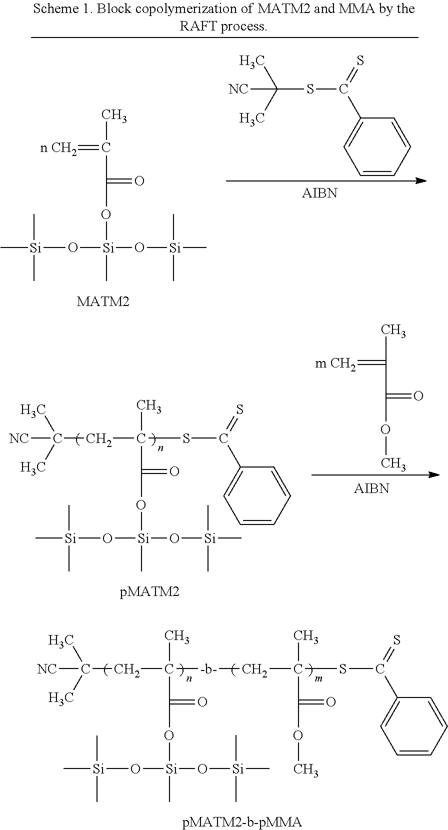

TABLE 1
Characteristics of the synthesized pMATM2-b-pMMA diblock
copolymers with theoretical Mₙ = 20,000 g/mol.

| | First block pMATM2 | | | | | | | |
|---|---|---|---|---|---|---|---|---|
| | [MATM2] = 1.5 mol/L, | | | Diblock copolymers pMATM2-b-pMMA | | | | |
| | [CPDB]/[AIBN] = 5, | | | [MATM2]/[MMA] from 10/90 to 50/50 | | | | |
| | xylene, 70° C. | | | [macro-CTA]/[AIBN] = 5, xylene, 70° C. | | | | |
| | | | MATM2 | | | MMA | [MATM2]/[MMA] | |
| | Mₙ | | conv. | M_{n,copo} | | conv. | molar ratio | |
| Example | (g/mol) | PDI | (%) | (g/mol) | PDI | (%) | Initial | Exp. |
| 1 | 6,800 | 1.12 | 96 | 21,000 | 1.04 | 90 | 10/90 | 11/89 |
| 2 | 9,800 | 1.10 | 95 | 18,600 | 1.08 | 91 | 20/80 | 22/78 |
| 3 | 11,700 | 1.13 | 94 | 19,400 | 1.10 | 92 | 30/70 | 31/69 |
| 4 | 15,200 | 1.13 | 94 | 20,000 | 1.14 | 93 | 50/50 | 52/48 |

General example of p(MATM2-co-MMA) production, with approximate Mₙ=20,000 g/mol, containing 20 mol % of MATM2 (Comparative Example 2)

Into a 250 mL round-bottomed flask equipped with a magnetic stir bar, MATM2 (10.710 g, 35.0 mmol), MMA (14.0 g, 140 mmol) CPDB (276.5 mg, 1.25 mmol) and AIBN (41.0 mg, 0.25 mmol) were dissolved in distilled xylene, and the volume of the solution was adjusted to 70 mL. Then, the reaction mixture was degassed through bubbling with argon, sealed, and then placed in an oil bath previously heated at 70° C., until no evolution of the monomer conversion. The polymer was precipitated into methanol, filtered and dried under vacuum for 48 h at room temperature for further characterizing its absolute number average molecular weight and polydispersity index. Comparative examples 1, 3 and 4 (Comp 1, 3 and 4) were produced in the same manner as comparative example 2 (Comp 2) except the relative ratios of MATM2 and MMA were varied accordingly.

TABLE 2
Characteristics of the synthesized p(MATM2-co-MMA) statistical
opolymers with theoretical Mₙ = 20,000 g/mol.

| | | | | | [MATM2]/ | |
|---|---|---|---|---|---|---|
| | | | MATM2 | MMA | [MMA] | |
| | Mₙ | | conv. | conv. | molar ratio | |
| | (g/mol) | PDI | (%) | (%) | Initial | Exp. |
| Comp 1 | 21000 | 1.04 | 95 | 93 | 10/90 | 10/90 |
| Comp 2 | 19200 | 1.10 | 94 | 93 | 20/80 | 19/81 |
| Comp 3 | 18100 | 1.05 | 93 | 93 | 30/70 | 30/70 |
| Comp 4 | 17600 | 1.06 | 90 | 92 | 50/50 | 51/49 |

The molar monomer conversions and molar ratios were determined by ¹H-NMR spectrometry. The absolute number-average molecular weight (Mₙ) and polydispersity index (PDI) were determined by TD-SEC (size exclusion chromatography with triple detection).

### Contact Angle Measurements

Purified polymers (powders) were dissolved in xylene at a solid content of 40 to 50% by weight. The polymer solutions were then applied with a 300 μm-bar coater on sand-blasted PVC panels previously washed with soap and rinsed with water and ethanol.

Contact angle measurements were performed with a Digidrop apparatus (GBX) equipped with a syringe and a flat-tipped needle, by placing 1A-droplets of deionized water (θ_{w}), glycerol (θ_{gly}) and diiodomethane (θ_{CH2I2}) on the coating surface. The reported contact angles values are an average of five measurements on different regions of the same sample.

The polar component yₛ^{p} and the dispersive yₛ^{d} component of the surface energy yₛ of the coating were calculated using the Owens Wendt method.¹ The results are shown in table 3 and illustrated in FIGS. 1, 2 and 3. The contact angle is the angle made by the liquid placed on the coating surface as illustrated in FIG. 1. 1. Owens, D. K.; Wendt, R. C. Estimation of the surface free energy of polymers. J. Appl. Polym. Sci. 1969, 13, 1741-1747

TABLE 3
Values of contact angles and surface energies

| | | | | | | | Owens Wendt | | |
|---|---|---|---|---|---|---|---|---|---|
| Exam- | Contact angles (°) | | | | | | (mJ/m²) | | |
| ples | 74 _{w} | ± | θ_{gly} | ± | θ_{CH2I2} | ± | γₛ | γₛ^{p} | γₛ^{d} |
| 1 | 102.2 | 3.12 | 100.5 | 1.87 | 61.2 | 4.45 | 24.6 | 0.2 | 24.4 |
| 2 | 98.4 | 1.14 | 99.1 | 1.55 | 70.1 | 1.5 | 21.0 | 1.2 | 19.8 |
| 3 | 101.2 | 1.41 | 102.6 | 1.13 | 75.2 | 0.8 | 18.3 | 1.1 | 17.2 |
| 4 | 103.6 | 0.68 | 106.2 | 0.79 | 80.9 | 0.83 | 15.6 | 1.2 | 14.4 |
| Comp 1 | 71.1 | 3.43 | 80.3 | 4.88 | 41.1 | 1.87 | 38.0 | 5.9 | 32.0 |
| Comp 2 | 89.1 | 4.49 | 81.4 | 10.83 | 45.8 | 3.11 | 35.2 | 1.3 | 33.9 |
| Comp 3 | 93.8 | 0.77 | 69.8 | 2.33 | 53.5 | 1.3 | 35.7 | 1.2 | 34.4 |
| Comp 4 | 97.1 | 2.35 | 93.5 | 2.76 | 57.2 | 3.03 | 27.6 | 0.6 | 27.1 |
| Comp 5 | 105.5 | 0.97 | 100.0 | 1.7 | 51.4 | 1.36 | 31.3 | 0.0 | 31.3 |

Comparative Example 5 is Intersleek 700, a commercial fouling release coating.

The above descriptions and examples are intended to provide a broad and generic teaching and enablement of a generic invention. The examples should not be read as imposing limits upon the general and generic terms used to describe the practice of the present invention. Generic and specific embodiments are described within the following claims.

Attention is directed to all papers and documents which are filed concurrently with or previous to this specification in connection with this application and which are open to public inspection with this specification, and the contents of all such papers and documents are incorporated herein by reference.

Where a feature of the invention and/or step of any method or process of the invention is optional herein it should be assumed that it may be combined with any one or more aspects of the invention detailed herein either alone or in combination with any one or more other optional feature(s) and/or step(s) herein except combinations where at least some of such features and/or steps are mutually exclusive. The combinations set out in the claims are those particularly preferred. The optional features for each exemplary embodiment of the invention, as set out herein are also applicable to any other aspects or exemplary embodiments of the invention, where appropriate.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An antifouling coating composition for application to a surface comprising a block copolymer binder the said copolymer including at least two polymer blocks A and B, at least 50% of the monomer units in block A being:—
(a) monomer residues of ethylenically unsaturated carboxylic, sulfonic or phosphonic acids wherein the said monomer residues have silyl ester side groups containing at least 3 silicon atoms in the silyl group.

2. A coating composition according to claim 1 wherein at least 50% of the monomer units in block B are (b) monomer units other than (a).

3. A coating composition as claimed in any preceding claim, wherein the monomer residues of polymer block A include (C₀-C₈ alk) acrylic, itaconic, maleic, fumaric or crotonic acid or the sulfonic or phosphonic acid equivalents thereof with a silyl ester group containing at least 3 silicon atoms.

4. A coating composition according to any of claims 1-3, wherein the silyl group is represented by formula (I):
—(Si(R⁴R⁵)—O)ₙ—Si—(R¹R²R³) (I)
wherein each R⁴ and R⁵ is independently selected from —O—SiR¹R²R³, or —O—(SiR⁴R⁵O)ₙ—SiR¹R²R³ or may be hydrogen or hydroxyl or may be independently selected from a C₁-C₂₀ hydrocarbyl radical,
and R¹, R² and R³ each independently represent hydrogen, hydroxyl, or may be independently selected from a C₁-C₂₀ hydrocarbyl radical,
and preferably when R⁴ or R⁵ is the radical —O—(SiR⁴R⁵O)ₙ—SiR¹R²R³, R⁴ and R⁵ within that said radical are not themselves —O—(SiR⁴R⁵O)ₙ—SiR¹R²R³,
and wherein each n independently represents a number of —Si(R⁴)(R⁵)—O— units from 1 to 1000 with the proviso that when no R⁴ and R⁵ group present in the silyl group includes a silicon atom n is at least 2.

5. A coating composition as claimed in claim 1, wherein the monomer residues having silyl ester side groups of polymer block A are derived from monomers of the following chemical formula: bis(trimethylsiloxy)methylsilylmethacrylate (MATM2).

6. A coating composition as claimed in claim 1, wherein monomer residues having silyl ester side groups of block A are derived from monomers of the following chemical formula: trimethylsiloxy bis(dimethylsiloxy) methacrylate (MADM3).

7. A coating composition as claimed in any of claims 1-6, wherein not all the monomer units of block A are type (a) and suitable comonomers for block A include (i) those that contain functional groups that may be reactive with optional functional groups of the block B polymer, and (ii) those that do not include such functional groups.

8. A coating composition as claimed in any of claims 1-7, wherein suitable monomers for block B include but are not limited to those polymerisable or copolymerisable to form polyesters, polyurethanes, polyethers, polyacrylics, polyvinyls, polyepoxides, polyamides, polyureas and copolymers thereof.

9. A coating composition as claimed in any one of claims 1-8, wherein suitable monomers or comonomers for block B include (i) those that contain functional groups that may or may not be reactive with optional functional groups of the block A polymer, and (ii) those that do not include such functional groups.

10. A coating composition according to any of claims 1-9 further comprising an antifouling effective amount of at least one biocide.

11. A substrate coated with a coating from an antifouling coating composition according to any of claims 1 to 10.

12. A block copolymer binder including at least two polymer blocks A and B, at least 50% of the monomer units in block A being:—
(a) monomer residues of ethylenically unsaturated carboxylic, sulfonic or phosphonic acids wherein the said monomer residues have silyl ester side groups containing at least 3 silicon atoms in the silyl group.

13. A process for producing a block copolymer binder according to claim 12 comprising the steps of polymerizing the unsaturated carboxylic, sulfonic or phosphonic acid monomers optionally with comonomers to produce block A, polymerizing the monomers of block B optionally with comonomers to produce block B, at least 50% of the monomer units in block A being:—
(a) monomer residues of ethylenically unsaturated carboxylic, sulfonic or phosphonic acids wherein the said monomer residues have silyl ester side groups containing at least 3 silicon atoms in the silyl group.

14. A process according to claim 13, wherein suitable block polymerization processes include anionic polymerization, cationic polymerization, living polymerization or controlled radical polymerization (CRP), living cationic polymerisations, ring opening metathesis, ROMP, group transfer polymerization, direct coupling of preformed living polymerization blocks, coupling of end functionalized prepolymers, polymerization by use of bifunctional initiators, and suitable combinations of the aforesaid techniques.

15. A process according to any of claim 13 or 14, wherein the block copolymers of the invention may be modified either during or post-polymerisation by chemical modification such as esterification, especially by silyl groups as mentioned herein, hydrogenation, hydrolysis, quaternization sulfonation, hydroboration/Oxidation, epoxidation, chloro/bromomethylation and hydrosilylation.
